(19) United States
(12) Patent Application Publication
(10) Pub. No.: US 2022/0283876 A1
(43) Pub. Date: Sep. 8, 2022

(54) DYNAMIC RESOURCE ALLOCATION FOR EFFICIENT PARALLEL PROCESSING OF DATA STREAM SLICES

(71) Applicant: NEC Laboratories Europe GmbH, Heidelberg (DE)

(72) Inventor: Felix Klaedtke, Heidelberg (DE)

(21) Appl. No.: 17/334,828

(22) Filed: May 31, 2021

Related U.S. Application Data
(60) Provisional application No. 63/155,809, filed on Mar. 3, 2021.

(51) Int. Cl. G06F 9/50; G06F 9/48; G06F 9/448

(52) U.S. Cl. CPC G06F 9/5088; G06F 9/5038; G06F 9/4881; G06F 9/4498

(57) ABSTRACT

A method for processing slices of a data stream in parallel by different workers includes receiving events of the data stream and forwarding the events to respective ones of the workers for updating respective states of the respective workers and for outputting results of data processing of the events. The states comprise hierarchically grouped state variables. At least one of the workers checks whether it is in a terminable state by checking that state variables that are owned by the worker in a current state of the worker have initial values.

### CROSS-REFERENCE TO PRIOR APPLICATION

Priority is claimed to U.S. Provisional Application No. 63/155,809, filed on Mar. 3, 2021, the entire disclosure of which is hereby incorporated by reference herein.

### FIELD

The present invention relates to a method, system and computer-readable medium for parallel processing of data stream slices.

### BACKGROUND

Data, which is often machine generated nowadays, e.g., by the devices and components of information technology (IT) systems is often processed and analyzed in real time. For instance, in the Internet of Things (IoT) context, various devices continuously sense or generate data, which cloud services collect and process. The processed data is then further forwarded to data consumers, which may combine it with data from others sources or make decisions based on it. The data must be analyzed continuously and efficiently. A processing step of the data is often realized by using stream processing frameworks and engines like APACHE FLINK, which process data in the form of data streams online.

### SUMMARY

In an embodiment, the present invention provides a method for processing slices of a data stream in parallel by different workers. The method includes receiving events of the data stream and forwarding the events to respective ones of the workers for updating respective states of the respective workers and for outputting results of data processing of the events. The states comprise hierarchically grouped state variables. At least one of the workers checks whether it is in a terminable state by checking that state variables that are owned by the worker in a current state of the worker have initial values.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates a data stream processing method and system including a data stream processor;

FIG. 2 schematically illustrates an architecture of the data stream processor with a dispatcher and multiple workers;

FIG. 3 illustrates a state update protocol according to an embodiment of the present invention;

FIG. 4 illustrates a worker creation protocol according to an embodiment of the present invention;

FIG. 5 illustrates worker termination protocol according to an embodiment of the present invention; and

FIG. 6 schematically illustrates a Mealy machine according to an embodiment of the present invention.

### DETAILED DESCRIPTION

In an embodiment, the present invention provides a method for analyzing data streams efficiently by dynamically creating and terminating instances that process slices of data streams in parallel. The method has minimal and reduced overhead in managing the instances. Also, the safe termination during runtime of an instance does not pause nor involve other instances. The method can be implemented in a system, such as a data stream processor and/or through instructions on a computer-readable medium that are executable by one or more computer processors with access to memory. Accordingly, embodiments of the present invention enable to securely terminate instances while decreasing the amount of computational resources required and increasing computational efficiency and throughput of the data processing.

The technical application areas of data stream processors are numerous and include system monitoring, system verification and debugging, intrusion, surveillance, fraud detection, data mining (applied, e.g., for advertising and electronic trading), and many others. The stream processing frameworks allow to implement stateful computations over data streams where the outcome of processing a stream element depends on previously processed stream elements. A simple example is the counting of specific events over a sliding window. Here, the state essentially consists of different time windows with counters that are updated when processing a stream element. Stateful computations are integral to many data analysis systems and at the core of the analysis. However, maintaining the state can be computationally expensive and the state updates can quickly become a bottleneck.

The data stream elements usually carry data values, which allow one to group stream elements. Such a grouping depends on the respective analysis and stream elements may occur in several groups. As an example, a variant of the counting example from above can assume that each data stream element carries as a data value one or multiple owners. The analysis counts specific events for each owner. The stream elements can be grouped by their owners and each owner can be counted for separately. Accordingly, a grouping of the data stream elements can be exploited by carrying out multiple (stateful) analyses over smaller data streams instead of a single (stateful) analysis over a single large data stream. In particular, the multiple analyses can be carried out in parallel, e.g., by distributing them over several computers and processing the smaller data streams in separate threads, with minimal dependencies between the threads. A dispatcher groups the stream elements and forwards them to the threads that analyze the stream elements for the respective data values. Advantageously, the grouping and forwarding of stream elements are inexpensive computations. In contrast, the state updates are usually computationally expensive, but parallelizing the state updates increases the overall throughput of the data stream processor.

If, however, the domain of the data values is not fixed in advance, unknown, or large, which is typically the case, it is not obvious how many resources for carrying out the state updates with respect to the different data values should be allocated. The load might change over time. Also, since the data must be processed online, it is not possible make a first pass over the data and collect the occurring data values. Furthermore, data streams are conceptually infinite, and hence the number of the occurring data values can be unbounded.

An embodiment of the present invention provides a method to group data stream elements and dynamically allocate resources for processing the data streams based on the elements' groups. In particular, during runtime, new processing instances for new data values are created from existing instances, and instances can also be terminated, thereby releasing the allocated resources. A technical challenge here is that the state maintained by an instance is lost when terminating the instance. An embodiment of the present invention provides a condition that can be efficiently checked to determine when it is safe to terminate an instance. The condition ensures that the analysis results (i.e., the output) are not altered by terminating instances. Furthermore, embodiments of the present invention have minimal and reduced overhead for the dispatcher, and do not globally pause the system for creating or terminating processing instances, thereby increasing computational efficiency and system throughput.

In an embodiment, the present invention provides a method for processing slices of a data stream in parallel by different workers. The method includes receiving events of the data stream and forwarding the events to respective ones of the workers for updating respective states of the respective workers and for outputting results of data processing of the events. The states comprise hierarchically grouped state variables. At least one of the workers checks whether it is in a terminable state by checking that state variables that are owned by the worker in a current state of the worker have initial values.

In an embodiment, the method further comprises receiving a termination request from at least one of the workers that determines it is in the terminable state, and sending a termination acknowledgement for terminating the at least one worker that sent the termination request.

In an embodiment, the termination request includes an event id, and the method further comprises, prior to terminating the at least one worker, checking that the event id in the termination request matches an event id in a key-value store for a key corresponding to the at least one worker that sent the termination request, wherein the at least one worker terminates itself based on receiving the termination acknowledgement.

In an embodiment, the method further comprises, for each of the received events, extracting data values and determining a key for the respective event based on the extracted data values using a key-value store having keys for each of the workers, wherein the events are forwarded to the respective workers based on the determined keys.

In an embodiment, the method further comprises updating the key-value store for each of the received events, each of the keys in the key-value store including an identification of at least one of the workers and/or a worker channel, and an event id of a most recent event sent to the respective worker.

In an embodiment, the method further comprises determining that, for one of the received events, the key does not have a corresponding worker, and generating a new worker.

In an embodiment, the new worker is generated by: creating a new worker channel; determining at least one parent worker using the key-value store; and initializing the new worker using the state of the at least one parent worker and the new worker channel.

In an embodiment, the at least one parent worker includes a primary parent and secondary parents, the new worker is initialized with the state of the primary parent, and at least some of the state variables from the secondary parents are used to update the state of the new worker.

In an embodiment, the method further comprises updating the key-value store to include the new worker and the new worker channel for the respective received event, and to remove the worker to be terminated and a corresponding worker channel.

In an embodiment, the method further comprises: receiving a termination request from at least one of the workers that determines it is in the terminable state; checking whether the at least one worker has any upcoming events for processing and sending a termination acknowledgement to the at least one worker only in a case that it is determined that the at least one worker does not have any upcoming events for processing; and the at least one worker terminating itself upon receiving the termination acknowledgement.

In an embodiment, the method further comprises receiving a termination request from at least one of the workers that determines it is in the terminable state, the termination request includes the state variables that are initial and not owned by the worker to be terminated, the method further comprising sending a termination acknowledgment to additional ones of the workers having smaller keys than the at least one worker and owning a subset of the state variables in the termination request.

In another embodiment, the present invention provides a data stream processor for processing slices of a data stream in parallel by different workers. The data stream processor comprises one or more processors and physical memory implementing a dispatcher and the different workers. The one or more processors are configured by instructions in the memory to facilitate the following steps: receiving events of the data stream and forwarding the events to respective ones of the workers for updating respective states of the respective workers and for outputting results of data processing of the events, wherein the states comprise hierarchically grouped state variables, wherein at least one of the workers checks whether it is in a terminable state by checking that state variables that are owned by the worker in a current state of the worker have initial values.

In an embodiment, the at least one worker is configured to send a termination request to the dispatcher upon determining that it is in the terminable state, the dispatcher is configured to check whether the at least one worker has any upcoming events for processing upon receiving the termination request and to send a termination acknowledgement to the at least on worker in a case it is determined the at least one worker does not have upcoming events for processing, and the at least one worker is configured to terminate itself upon receiving the termination acknowledgment.

In an embodiment, the at least one worker is configured to send a termination request to the dispatcher upon determining that it is in the terminable state, wherein the termination request includes the state variables that are initial and not owned by the at least one worker, and wherein the dispatcher is configured to send a termination acknowledgment to the at least one worker and additional ones of the workers having smaller keys than the at least one worker and owning a subset of the state variables in the termination request such that the at least one worker and the additional ones of the workers terminate.

In a further embodiment, the present invention provides a tangible, non-transitory computer-readable medium having instructions thereon which, upon being executed by one or more processors, facilitate execution of the steps of any method according to an embodiment of the present invention.

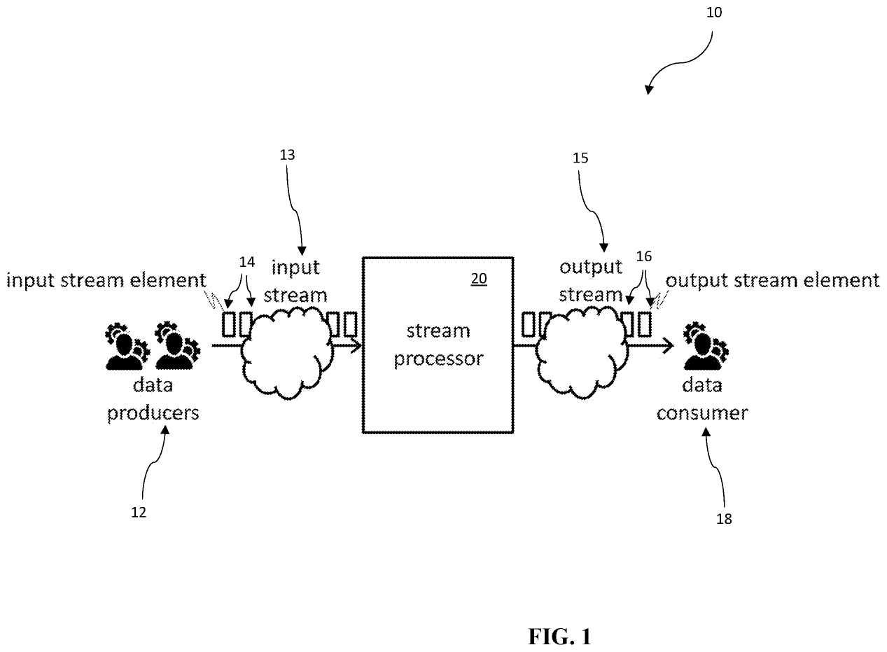

FIG. 1 schematically illustrates a data stream processing method and system 10 according to an embodiment of the present invention. The overall system 10 consists of multiple components. These components could be, for example, software components of a cloud-based IT system or IoT devices, or a mixture of both. Some of the system components produce a stream of data and such components are referred to herein as data producers 12. For instance, an IoT sensor may measure the room temperature every second, and send each of its measurements to a stream processor 20 as an input stream 13 made up of input stream elements 14 (e.g., the individual measurements with or without a timestamp). The stream processor 20 is a platform that hosts a service for processing and analyzing the received input stream 13, which often includes some sort of data aggregations, e.g., the average temperature measured by the sensors over a sliding time window. The stream processor 20 in turn sends the analysis results to data consumers 18 as an output stream 15 made up of output stream elements 16 (e.g., aggregations of measurements). It is possible that the output stream 15 consists of the same or fewer stream elements than the input stream 13. For example, for each temperature, the aggregation could be the mean or average of the last X temperatures, and each temperature could be annotated by a mean/average value. In principle, it is even possible that the output stream 15 consists of more elements. A data consumer 18 may just collect the data, process it further, or may make decisions based on the data received. Both the input stream 13 and the output stream 15 of the data stream processor 20 are data streams. The elements of a data stream are also referred to herein as also events, and a data stream is also referred to herein as an event stream.

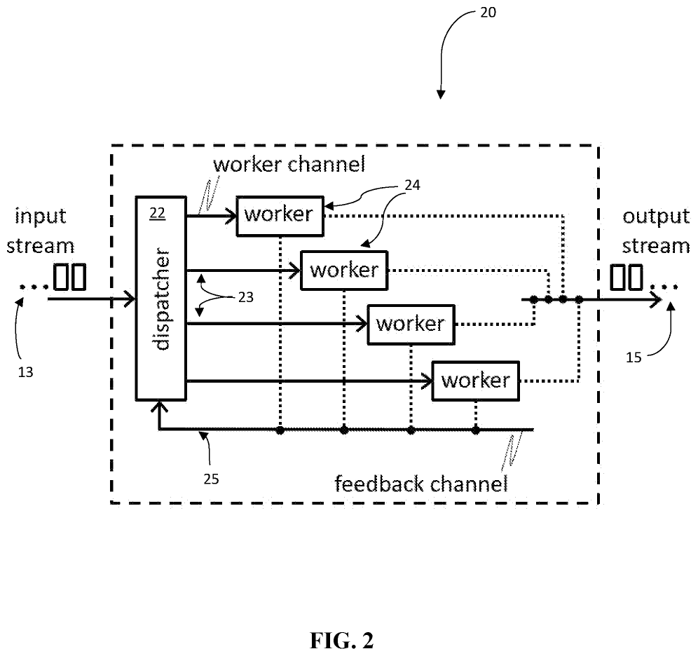

FIG. 2 schematically illustrates the data stream processor 20 and how events, as elements of the input stream 13, are processed by the data stream processor 20. A dispatcher 22 iteratively receives events from the data producers via the input stream 13. The dispatcher 22 classifies the received events, for example using an event identifier and/or timestamp associated with the event, and/or using values extracted from the events. According to an event's classification, the dispatcher 22 forwards the events to workers 24, which carry out the (stateful) analysis. An event can be relevant for updating the state of several workers 24. In this case, the dispatcher 22 forwards the event to multiple workers 24. To this end, each worker 24 maintains a state, which is updated whenever it receives an event from the dispatcher 22. Each state update may result in some output, which the worker 24 sends to the data consumers.

The dispatcher 22 and the workers 24 can be the same or different computer devices (e.g., servers, processors with access to physical memory containing code for executing the code, etc.) and can run concurrently (e.g., they are executed on different central processing units (CPUs) or in separate operating system threads). Furthermore, the dispatcher 22 and the workers 24 communicate asynchronously with each other by sending and receiving messages over worker channels 23. There is a worker channel 23 for each of the workers 24, and the worker channels 23 are created by the dispatcher 22 for communication of messages to the individual workers 24. The worker channels 23 are created upon the creation of the respective workers 24. As discussed further below, when creating a new worker 24 starting with a preworker, secondary parents can also send messages over the associated worker channel 23, which is also created when creating the new worker 24, to the preworker. The workers 24 have a common feedback channel 25 for communication to the dispatcher 22. The channels 23, 25 are reliable, meaning that messages are not altered, dropped or inserted. The channel communication is unidirectional. Alternatively, if the data stream processor is, e.g., implemented on a single CPU with possibly multiple cores, then the dispatcher 22 and the workers 24 can also communicate via shared memory with each other. Various programming languages and libraries exist that provide support for concurrent process execution, and for channel and shared memory communication. Furthermore, the data stream processor 20 also communicates with the data producers and consumers. Here, it can be provided to not impose reliable channels. For instance, when messages can arrive out of order, the workers 24 may handle such out-of-order events or they may be handled by an additional component that reorders incoming events. The data stream processor 20 may also have additional components, e.g., for filtering, aggregating, sanitizing and/or interpreting events.

In the following, a discussion of additional terminology and an example illustrating underlying concepts are provided, followed by a discussion concretizing the components of the architecture shown in FIG. 2 and their behavior to cater for the dynamic creation and termination of workers 24.

It is assumed that each received event in the input stream 13 can be uniquely identified. In particular, the data stream processor 20 has an event identifier (event id) available. For example, events may be timestamped and these timestamps are unique. In this case, the events' timestamp can be used as event ids. However, it is not required that the events be received in the order of their timestamps. Alternatively, the data stream processor 20 could maintain a counter for the events received and attach the counter's current value to a received event. In this case, the attached counter values can be used as event ids.

The dispatcher 22 has a function available that extracts the data values of an incoming event. The incoming event is a sequence of bytes, which may be encrypted (if encrypted, the dispatcher would first decrypt it). In the example below, “flag(Alice)” would be such a string. The function would parse the string, classify the event as a flag event, and extract Alice as a data value. If the events are provided by JavaScript object notation (JSON) objects, the function also has to parse and interpret the string, and identify/extract the data values, for example in accordance with the following pseudocode

```
  {
    “event”: 1,
    “user”: “Alice”
    }
and
  {“event”: 2,
    “from”: “Bob”,
    “to”: “Alice”,
    “file”: “foo.txt”
}
```

where flag events carry the number 1 in the “event” field for identification and send events carry the number 2 in the “event” field.

Such a function is also described in the example below, as well as the keys for an event. This function is application dependent and can be implemented in a number of different ways in embodiments of the present invention.

From the extracted data values (and the data values in previously received events), the dispatcher 22 determines the relevant workers 24. To this end, a worker 24 is identified with a key, which is unique and determined by the events' data values. Furthermore, since new workers originate from the existing workers 24, it is provided that the keys can be partially ordered. The set of keys contains a unique least element. In particular, a genesis worker for a key receives the data stream elements with no data values and all other workers 24, directly or indirectly, originate from it. Furthermore, this genesis worker runs from the beginning and never terminates.

The following example illustrates keys, their relation to the events' data values, and their partial ordering.

Example: In the following example, the input stream 13 consists of flag, unflag, and send events. Flag and unflag events refer to a user, for example the events' data value is a user. Send events refer to the transferring of a file from a user to another user, i.e., the events' data values are the source user, the destination user, and the transferred file. As an instance, consider the following prefix of an input data stream:

flag(Alice) send (Bob,Alice,foo.txt) flag(Bob) send (Alice,Bob,goo.txt) flag(Charlie) unflag(Bob) . . .

User Alice is first flagged, then user Bob sends the file foo.txt to Alice, afterwards Bob is flagged, and Alice sends the file goo.txt to Bob, finally, the user Charlie is flagged after Bob is unflagged. The output data stream should consist of the send events of the input data stream. However, the send events should be delayed when one of the users is flagged until both users become unflagged. If, however, the delaying of a send event exceeds a given threshold, the send event should be tagged and output. For the input stream 13 in the example above, both send events are delayed, since at least one of the users is flagged. Both send events may even be tagged, depending on whether and when corresponding unflag events are received.

The following key set is defined with three different kinds of keys: (1) the empty key, (2) keys for a single user like Alice and Bob, and (3) keys that consist of the sending user, the receiving user, and the transferred file. The keys are partially ordered. For instance, the single user keys for Alice and Bob are incomparable, and the single user key for Alice is less than the keys where the sending or receiving user is Alice.

With this key set, the above data stream would be “sliced” into the following substreams:
flag(Alice) . . .
flag(Bob) unflag(Bob) . . .
flag(Charlie) . . .
flag(Alice) send (Bob,Alice,foo.txt) flag(Bob) unflag(Bob) . . .
flag(Alice) flag(Bob) send (Alice,Bob,goo.txt) unflag(Bob) . . .

The first substream is for the key of kind (2) with the user Alice. Similarly, the second substream and third substream are for the keys of kind (2) with the users Bob and Charlie, respectively. The fourth substream is for a key of kind (3) with the sending user Bob, the receiving user Alice, and the transferred file foo.txt. The fifth substream is accordingly the sending user Alice, the receiving user Bob, and the transferred file goo.txt. Flag and unflag events occur in multiple sliced substreams. In particular, if a key k is equal to or greater than a key k′, then the substream for the key k′ is a substream of the key k.

The respective worker 24 for a key should appropriately handle the events it receives. The worker 24 for the key of the kind (1) is trivial. The workers 24 for the keys of kind (2) are straightforward. These workers 24 for the keys of kind (2) keep track of whether the corresponding user is currently flagged. Similarly, a worker 24 for a key of kind (3) keeps track which of its two users is currently flagged. Additionally, for delaying the send events, the worker 24 has a timer and records the receiving times of the send events. Whenever outputting a send event, the worker 24 tags it if its delay exceeds the threshold. Furthermore, the dispatcher 22 should ensure that for each occurring key, the corresponding worker 24 exists. If it does not exist yet, it should be created and initialized appropriately. The workers 24 for the keys of kind (2) (and also (1) in some cases) are used to initialize the workers 24 for the keys of kind (3), as further discussed below.

Advantageously, there is some flexibility in choosing the key set. An alternative and extreme case is the singleton key set. This key set results in a single worker 24 to which the dispatcher 22 forwards all events. Another possible key set in the example above, with a coarser partial order, consists of the keys of the kinds (1) and (2), and the kind (3′), where the transferred file is not part of the key and neither is the information whether a user is the sending or receiving user. This key set results in more complex workers 24 for the keys of kind (3′). Intuitively speaking, for a key set with a finer partial order, the dispatcher 22 will manage more workers 24 and a worker's state will be simpler, in particular, more workers 24 will run but individual ones will receive fewer events. Accordingly, there is a tradeoff in choosing the key set and the choice can be application dependent.

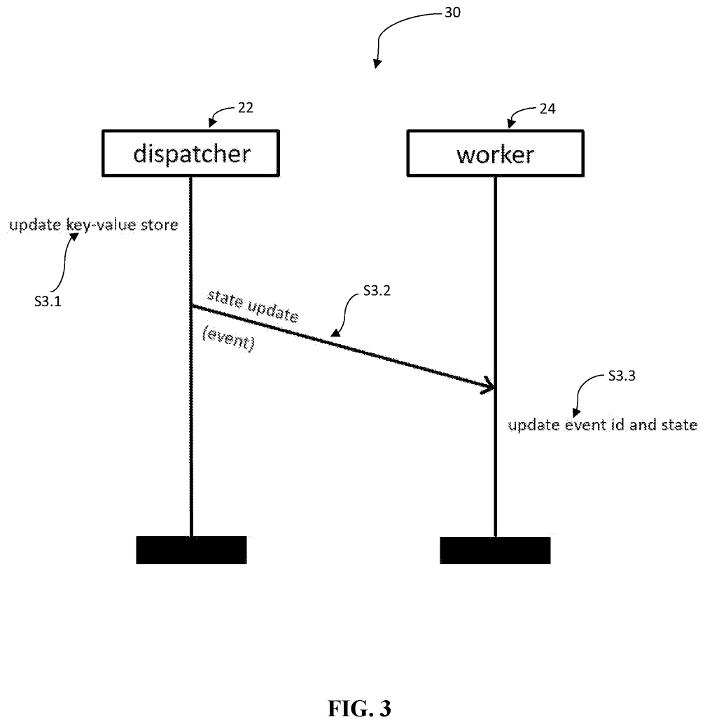

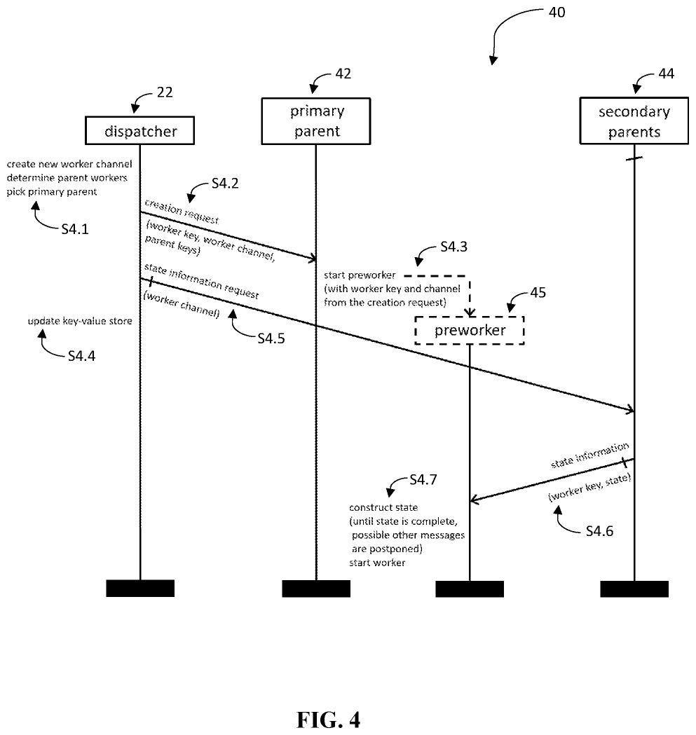

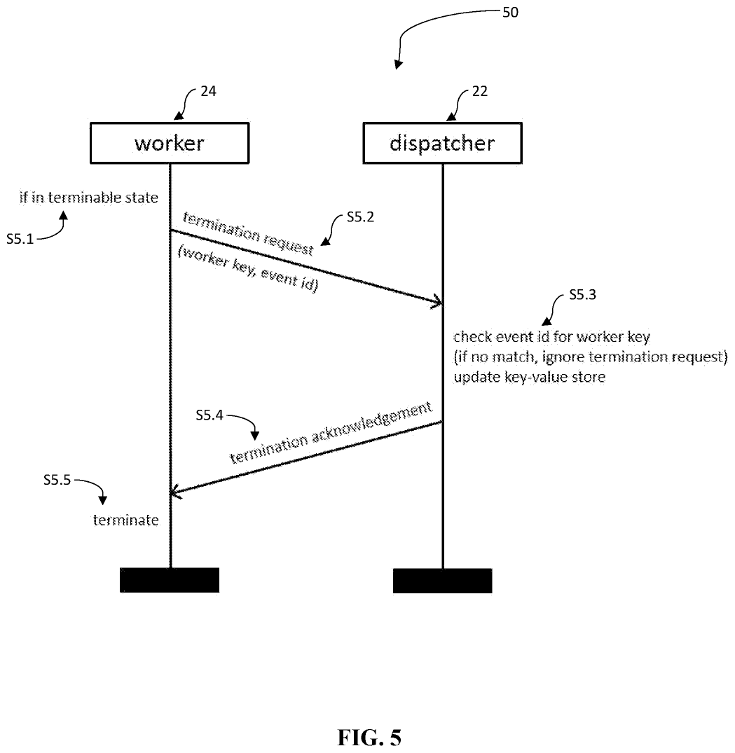

In the following, further details of the dispatcher 22 and components of the workers 24 in the architecture of the data stream processor 20 shown in FIG. 2 are provided. These components interact with each other using the communication protocols 30, 40, 50 shown in FIGS. 3-5. With reference thereto, the message type is written above an arrow and the data that is transmitted below the arrow. The protocols 30, 40, 50 send the messages in plain text. For security reasons, the dispatcher 22 and the workers 24 (and also the data producers and data consumers) may send their messages encrypted. Additionally, a message may also include nonces, the sender, the receiver, and hashes to prevent, e.g., the replay of messages. The receiving side can implement additional corresponding checks for the received messages. There are three protocols: one for updating a worker's state (see FIG. 3), one for creating a new worker 24 (see FIG. 4), and one for terminating a worker 24 (see FIG. 5). A state update and the creation of a worker is initiated by the dispatcher 22. The termination of a worker 24 is initiated by the worker 24.

Dispatcher: The dispatcher 22 maintains a key-value store of the active workers 24. Advantageously, implementing the key-value store by a prefix tree (e.g., with a wildcard symbol*as a placeholder for values of key components) allows to quickly determine the parents 42, 44, in particular the workers' keys in the partial order that are the direct predecessors of a given worker key. The keys of the key-value store are the keys of the workers 24. The value for a key, according to an embodiment, consists of (1) the worker channel 23, i.e., the channel over which the worker 24 for the given key receives messages, and (2) the event id of the last input event that the dispatcher 22 has sent to the worker 24.

The dispatcher 22 is programmed to operate as discussed in the following. The dispatcher 22 continuously listens on the incoming channels, in particular the feedback channel 25 and the channel from the data producers carrying the input stream 13.

A message, in particular a termination request, on the feedback channel 25 is processed as follows:
1. The dispatcher 22 compares the event id in the termination request with the event id stored in the dispatcher's key-value store for the worker key in the termination request.
2. If the event ids do not match, the termination request is outdated, e.g., the dispatcher 22 sent an event to the worker 24 earlier before processing the termination request. The dispatcher 22 ignores outdated termination requests.
3. Otherwise, if the event ids match, the dispatcher 22 acknowledges the termination and updates its key-value store, in particular the dispatcher sends an acknowledge message to the worker and removes the respective key-value pair.

Depending on the underlying semantics for the worker channels 23, it may suffice to only close the respective worker channel 23, which signals the respective worker 24 to terminate. Messages that are already in the respective worker channel 23 are processed by the respective worker 24 before it terminates. However, the 22 dispatcher will not send other messages over this worker channel 23 after acknowledging the worker's termination.

A message, in particular an event, from a data producer is processed as follows:
1. The dispatcher 22 extracts the data values from the event and determines the keys (based on extracted data values and the keys of the current workers).
2. For each key for which no worker exists, the dispatcher 22 creates a new worker channel 23, computes the parent workers 42, 44, picks a primary parent worker 42, and sends the creation requests to the parent workers 42, 44.
3. The dispatcher 22 adds the new worker 24 to the key-value store. After all the messages for creating the workers 24 have been sent, the dispatcher 22 forwards the event to the relevant workers 24 and updates its key-value store.

For the step 1 of extracting the data values from the event and determining the keys with respect to the example given above, there are two cases to consider:
1. Flag and unflag events:
   a. The dispatcher 22 extracts the data value from the event, i.e., the user Alice in the example.
   b. From the key-value store the dispatcher determines all the workers' compatible keys for the event's data values, i.e., in the example, the empty key (kind 1), the key of kind (2) for the user Alice and keys of kind (3), where one of the users is Alice. It is possible that the key-value store may only contain one “compatible” key, namely, the empty key.
   c. Each of the worker keys and the event's data values are combined. This may result in a key of kind (2) and at most three keys of kind (3), where user Alice is the “from” user but not the “to” user, user Alice is the “to” user but not the “from” user, and user Alice is the “from” and “to” user.
   d. For each resulting key, the dispatcher 22 sends the event to the worker 24, provided the worker 24 already exists. Otherwise, the worker 24 is first created and then the event is sent to the worker 24. The dispatcher 22 also updates its key-value store (see steps 2 and 3 of the message processing above).
2. Send events: Similar to the above case. Again, the dispatcher 22 extracts the data values from the event, i.e., the users Alice (from) and Bob (to), and the file F. Then, the dispatcher 22 determines all the workers' “compatible keys”. In this case, there are at most two keys, namely, the empty key (kind 1) and the one of kind (3) with users Alice and Bob and the file F. The next steps are similar to the case above. A dispatcher 22 may determine the keys differently, however, depending on the application and the correctness requirements about output stream. Furthermore, for different key types, the determined keys can also be different as discussed above.

Workers: Each worker 24 maintains a state, which is updated when receiving an event from the dispatcher 22. Furthermore, each worker 24 stores the event id of the last input event for which the worker 24 updated its state. A worker 24 can also receive messages from the dispatcher 22 for creating a new worker, for sending state information, and for termination.

A worker 24 continuously monitors its incoming worker channel 23. The different messages are processed as discussed in the following.

When receiving an event, the worker 24 performs the following steps:
1. The event is transformed into an internal event.
2. The worker 24 updates its state for the internal event. This update also produces some internal output event.
3. The internal output event is transformed into output events, which are sent to the data consumers.
4. The worker 24 updates its event id, in particular the id of the last processed event.

When receiving a creation request, the worker 24 creates and starts a preworker 45, which the worker 24 initializes with its state, and the key and worker channel 23 from the creation request. Additionally, if the message also contains a list of further parents 42, 44, this list is given to the preworker 45. The preworker 45 operates as follows:
1. The preworker 45 continuously monitors its worker channel 23 until it has received state information from all parents 42, 44.
2. The preworker 45 initializes and completes its state accordingly. Other messages (e.g., state updates), which it may also receive over the worker channel 23), are stored in a first-in, first-out (FIFO) buffer and executed after the state is completely initialized. Afterwards, the preworker 45 finalizes, i.e., it becomes a “normal” worker 24.

When receiving a state information request, the worker 24 sends its key and its state over the worker channel 23 that is provided in the request.

When receiving an acknowledge message for the worker's termination, the worker 24 terminates.

A worker 24 can also send messages to the dispatcher 22 over the feedback channel 25. In particular, the worker 24 can request its termination (see the protocol 50 in FIG. 5). Termination requests can, e.g., be sent after the worker 24 has processed an event or if the worker has been idle for a certain time. However, for sending a termination request, the worker 24 should be in a terminable state. Otherwise, it would not be safe to terminate the worker 24. It is in particular advantageously provided according to embodiments of the present invention that a worker 24 can determine by itself whether it is in a terminable state. Another particularly advantageous operation on a worker's state is its initialization. As discussed above, a preworker 45 initializes a new worker's state by combining the states of multiple parent workers 42, 44 (see the protocol 40 in FIG. 4). In the following, details for realizing these two operations on a worker's state according to embodiments of the present invention are provided.

Data Streams: Σ denotes the set of input events and Γ denotes the set of output events. Σ* and Γ* denote the sets of finite sequences of input and output events, respectively. Both sets include the empty sequence ∈. A data stream is a finite or infinite sequence of elements of the respective event set.

In the example above, the set of input events Σ is the set of flag, unflag, and send events. For example, flag(Alice) is an element of Σ. The set of output events Γ is the set of send events and their tagged counterparts. For example, send (Alice,Bob,foo.txt) and its tagged counterpart (by the superscript !) send^{!} (Alice,Bob,foo.txt) are elements of Γ. Both Σ and F are infinite sets in the example if there are infinitely many users or files.

Keys: K denotes the set of keys. The keys are partially ordered. k [symbol] k′ if the key k∈K is smaller than or equal to the key k′∈K. Furthermore, K′s partial order [symbol] has a unique least element, denoted by ⊥, and has only finite chains. Wₖ is the worker with the key k∈K.

In the example above, ⊥ is the empty key, i.e., the key of kind (1). It is the case that ⊥ [symbol] k, where k is a key of kind (2). In turn, k>k′, where k′ is a key of kind (3), where the user of k is the sending or receiving user of k′. Since a partial order is transitive, it is also the case that ⊥ [symbol] k.

If the dispatcher 22 sends an event to the worker Wₖ then it sends the event also to all currently existing workers W_{k′}, with k>k′. In the example, if a flag event is sent to a worker 24 with a key of kind (2) it is also sent to the workers 24 with a key of kind (3) that extend the key of kind (2).

Workers: A worker 24 is essentially a state machine that updates its state for each received input event. Furthermore, for each state update, the worker 24 may produce output events that the worker sends to the data consumers. Formally, it is assumed that a worker 24 comprises the following components: (i) a Mealy machine [symbol] =(Q, Σ′, Γ′, q₀, δ, η) with a possibly infinite state set Q and infinite alphabets Σ′ and Γ′, the initial state q₀∈Q, the transition function δ: Q×Σ′→Q, and the output function η: Q×E→Γ′; (ii) a function in: Σ→Σ′ that preprocesses incoming events. In other words, in(e) is the internal input event for which the worker 24 updates its state; and (iii) a function out: Γ′→Γ* that postprocesses internal output events before sending the output to the data consumers. A state update can result in sending multiple output events. In particular, the worker 24 sends no output events if out(e)=␣.

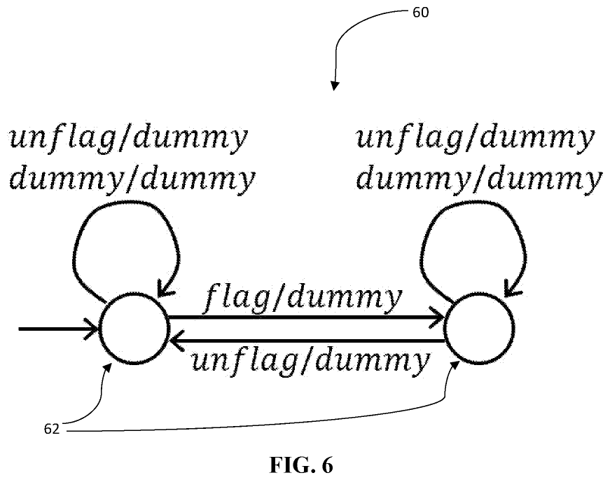

For an illustration of a worker's components, the example above with the flag, unflag, and send events is used again. A worker 24 for the key of kind (2) for the user u has the function in: Σ→ρ′ that cuts off the user name from flag and unflag events. That is, for Σ′={unflag, flag, dummy} it is the case that in(unflag(u))=unflag and in(flag(u))=flag. Additionally, for u′≠u, it is defined in(unflag(u′))=in(unflag(u′))=dummy, and for send events, it is defined in(send(_,_,_))=dummy. Alternatively, these input events could be dropped. The dispatcher 22 does not send events to workers 24 for keys of kind (2). The function out: Γ′→ΓF* is trivial as the worker 24 never outputs something. That is, Γ′={dummy} and out(dummy)=∈. The worker's Mealy machine 60 is shown in FIG. 6.

The components for a worker 24 of a key of kind (3) are more involved. In particular, the Mealy machine for this worker 24 of kind (3) has an infinite state set, and has external tick events for the progression of time. This Mealy machine also has two subcomponents that are similar to the Mealy machine 60 in FIG. 6. The subcomponents keep track of which of the two users is currently flagged. The circles 62 are states of an automaton. In this simple example, either the user is flagged (right state) or unflagged (left state). The labeled arrows indicate the transitions. In the “unflagged” state with a flag event, the automaton enters the “flagged” state. Initially, the user is in the “unflagged” state (arrow with no source state). Preferably, Mealy machines are used as a formalism in embodiments of the present invention as they provide a uniform model for representing state programs. It is not required that the state set and the alphabets are finite sets, which is usually the case in the standard definition of Mealy machines.

In the following, [symbol] ₖ, inₖ and outₖ denote the Mealy machine, the input function, and the output function of the worker Wₖ, with k∈K. It is assumed that the state set Q of a Mealy machine [symbol] ₖ of a worker Wₖ is the Cartesian product D₁× . . . ×Dₙ_{ₖ} where each Dᵢ is a finite or infinite domain. The Mealy machine [symbol] ₖ can be given indirectly by a program in a higher level programming language like C, Java, Rust, or Go with the state variables v₁, . . . , vₙ_{ₖ} where each variable vᵢ has the type Dᵢ, e.g., the 64 bit machine integers. In particular, q₀ is the initial assignment of the variables and the transition function δ can be provided by a program that updates the state variables for an input from Σ′. According to an embodiment of the present invention, it suffices that the there is a bisimulation between the Mealy machine and the program's transition graph for updating the worker's state, allowing more flexibility for providing the state updates for workers. A state (d₁, . . . , dₙ) of a Mealy machine is abbreviated in the following by d̅ with possible annotations and where n is clear from the context.

For keys k, k′∈K with k [symbol] k′, it is provided that the Mealy machine [symbol] ₖ is a subcomponent of the Mealy machine [symbol] ₖ:

[symbol]

ₖ's state set D′₁× . . . ×D′ₙ_{_{k′}} extends [symbol] ₖ's state set D₁× . . . ×Dₙ_{ₖ}. That is, nₖ≤nₖ′ and, without loss of generality, Dᵢ=D′ᵢ, for all i with 1≤i≤nₖ. Intuitively speaking, every state variables of [symbol] ₖ corresponds to a state variables of [symbol] ₖ′ and their types match. [symbol]
k's initial state (q′₀₁, . . . , q′₀ₙ_{_{k′}}) extends initial state (q₀₁, . . . q₀ₙ_{_{k′}}). That is, q₀ᵢ=q′₀ᵢ for all i with 1≤i≤nₖ. Intuitively speaking, the common state variables have the same initial values. [symbol]
ₖ's transition functions δₖ, extends [symbol] ₖ's transition function δₖ. That is, for all b∈Σ and all d̅, d̅′∈D′₁× . . . ×D′ₙ_{_{k′}} with δ_{k′} (d̅,in_{k′}(b))=d′ it holds that δₖ ((d₁, dₙ_{ₖ}), inₖ(b))=(d′₁, . . . , d′ₙ_{ₖ}). Intuitively speaking, ≈ₖ and [symbol] _{k′} make the same updates to the common state variables.

For illustration, the workers 24 in the example with the flag, unflag, and send events are again used. The workers 24 with keys of kind (3) have two Boolean state variables for keeping track which of the users (sending or receiving) is currently flagged. The initial value of both Boolean state variables is false, meaning in this case both users are unflagged. The programs of both Boolean state variables are subcomponents. Furthermore, the workers 24 have a state variable for storing and postponing the received send events with additional timers. Initially, the list is empty. A worker 24 with a key of kind (2) has a single Boolean state variable to keep track of whether the user is flagged. The program for toggling the Boolean state variable occurs twice as subcomponent in the workers 24 with a key of kind (3). The trivial worker with the key of kind (1) has no state variables.

State Initialization: A preworker 45 first inherits the values of the state variables of the primary parent 42. Furthermore, the preworker 45 may also receive state information from other workers 24. In particular, the preworker 45 receives values for state variables from the secondary parents 44. The preworker 45 carries over these values, e.g., the preworker 45 sets its respective state variables to the received values. For some state variables, the preworker 45 does not receive values. These variables remain at their initial value. These state variables can be referred to as the state variables that are owned by the worker 24. Thus, as used herein, the “owned” state variables of a worker are the ones that do not receive a value from a parent worker.

As an example, consider the creation of a worker 24 with a key of kind (3) from the example above. The worker's state is initialized as follows, depending on the parent workers 42, 44. If the parent workers 42, 44 are one for the sending user and another one for the receiving user, then the state of the new worker 24 inherits the status of the two users. One of the parents is the primary parent 42 and the other one is a secondary parent 44. No value is received for postponed send events. The corresponding state variable, which is owned by the worker 24, is set to the initial value, e.g., the empty list. If, e.g., the worker 24 has a single parent 42 and only receives a value for the state variable for the sending user, then the new worker 24 owns two state variables: the state variable for the receiving user and the state variable for the postponed send events.

Termination Check: For checking whether it is safe for a worker 24 to terminate, it suffices according to an embodiment of the present invention to check whether the worker's owned state variables of the current state have all initial values. Such a check is effective and can be implemented efficiently. Advantageously, if the worker 24 would terminate, then it could be efficiently recreated (possibly from other parent workers 42, 44). Moreover, the worker's state variables would be initialized correctly when it is recreated. Hence, it is advantageously provided in embodiments of the present invention to efficiently determine that it is safe to terminate. Also advantageously, the worker 24 itself can determine this and request termination. If there are unprocessed events in the respective worker channel 23, the dispatcher 22 can ignore the termination request from the worker 24.

As an example, consider a worker 24 with a key of kind (2) from the example above. It owns the state variable that keeps track of the user's status. The worker 24 can request termination if the user is not flagged. As another example, consider a worker 24 with the key of kind (3) from the example above. Assume that the owned state variables of the worker 24 are the state variable for the postponed send events. The worker 24 can request termination if there are currently no pending send events, e.g., the list is empty.

Extension: An extension according to an embodiment of the present invention is to include the worker's not owned state variables in a termination request that are initial. As discussed above, a worker 24 can request its own termination if it is in a terminable state, e.g., its owned state variables all have an initial value. If a non-owned state variable has an initial value, the termination request may be extended to other ones of the workers 24. For example, assume a worker W of kind (3) stores currently no postponed send events. If this is the only state variable it owns, it can request its termination. Additionally, assume that both users are not flagged. In this case, also these state variables have initial values, but they are not owned by the worker W. These state variables are owned by workers of kind (2). However, the dispatcher 22 could also terminate those workers. Overall, the termination request for the worker W could be used by the dispatcher 22 to also terminate some parent workers 42, 44. For this, the worker W must include in its message which state variables are initial. The dispatcher 22 could then not only acknowledge the termination of the worker 24 from which the dispatcher 22 received the termination request, but could also acknowledge the termination of all workers 24 with smaller keys that own a subset of the state variables listed in the termination request. In particular, a partial order on the keys of the workers is used and, for a given key k, the dispatcher 22 can enumerate the currently stored keys that are smaller than k. This can be done (naively), e.g., by traversing the elements in the key-value store. Accordingly, in this embodiment, the dispatcher 22 would send termination acknowledgements to workers 24 that may not have sent a termination request previously. All workers 24 that receive a termination acknowledgement terminate. In this embodiment, the dispatcher 22 knows a worker's owned state variables, e.g., by also storing them in its key-value store.

As discussed above, some care is taken for the output of workers 24. The output of workers Wₖ and Wₖ, with k [symbol] k′ are also advantageously aligned. Otherwise, output events may, e.g., not occur or occur multiple times. In the example above with the flag, unflag, and send events, the workers' output is trivially aligned since only workers 24 of kind (3) produce output. The workers 24 with keys of kind (1) and (2) are auxiliary workers for creating the workers 24 with keys of kind (3).

In an embodiment, the present invention provides a method for dynamically allocating resources for processing slices of data streams concurrently, the method comprising the following steps:
1. The workers' state consists of states variables. The state variables are hierarchically grouped.
2. The dispatcher 22 continuously receives events and forwards them to the relevant workers 24, which updates their state variables accordingly and output their results.
3. If a worker 24 does not exist, the dispatcher 22 initiates its creation (see the protocol in FIG. 4):
   a) The dispatcher 22 determines the parent workers 42, 44 and informs these parent workers 42, 44.
   b) The new worker 24, e.g., a preworker 45, initializes its state by setting some of its state variables to the values of the state variables of its parent workers 42, 44.
   c) The new worker 24 starts processing events, which it receives from the dispatcher 22.
4. A worker 24 can terminate (see the protocol in FIG. 5):
   a) A worker 24 checks its current state to determine whether it can terminate.
   b) If the check is affirmative, the worker 24 requests the dispatcher 22 to terminate.
   c) When the dispatcher 22 receives a termination request, it acknowledges the termination, provided that the request is not outdated. In case the request is outdated (e.g., because the worker's state has been updated in the meantime), the dispatcher 22 ignores the termination request.

A dispatcher 22 orchestrates and coordinates the workers 24. To this end, the dispatcher 22 stores information about the workers 24 and updates it whenever a worker's configuration changes (e.g., processing an event, creating a new worker 24, and terminating a worker 24). Furthermore, the dispatcher 22 triggers the workers 24 to update their states and for worker creation. Particularly advantageous embodiments of the present invention focus on the termination of workers 24, which provide for the improvements to the computer system of the data stream processor 20 and its network of workers 24 discussed above.

FIG. 3 illustrates a protocol 30 for the dispatcher 22 and a respective worker 24 to direct an incoming event and update state according to an embodiment of the present invention. In a step S3.1, the dispatcher 22 updates its key-value store. The dispatcher 22, upon receiving an event, extracts the data values from the event to determine from the key-value store the respective worker 24 to forward the event to in step S3.2 in a state update message. In particular, the stored event id is updated in the respective key-value pair. If the respective worker 24 does not exist, a new worker is created according to an embodiment of the present invention and the key-value store is updated to include the new worker. Then, the respective worker 24 updates the event id and its state based on the processing of the event in step S3.3. The worker 24 must keep track of the last processed event. The event id is included in a termination request and the dispatcher 22 also stores the event id in its key-value store. This way, the dispatcher 22 is able to recognize unprocessed events for the worker 24 and does not acknowledge a termination request if the worker 24 has unprocessed events in the channel.

FIG. 4 illustrates a protocol 40 to create a new one of the workers 24 according to an embodiment of the present invention. As discussed above, upon receiving an event, the dispatcher extracts the data values and determines the appropriate keys from the key-value store. In a case where it is determined that there is a key for the event for which no worker exists, the dispatcher 22 creates a new worker channel for the new worker, determines parent workers 42, 44 and picks a primary parent 42 in step S4.1.The dispatcher 22 may create new keys as discussed above. This results in adding new key-value pairs to the dispatcher's key-value store. Furthermore, the dispatcher 22 contacts the relevant workers to create the new workers. An invariant is that when a worker creates a preworker for the key k (see FIG. 4), then there is a pair with the key k in the key-value store of the dispatcher 22. Channel creation depends on the programming language used and whether shared memory is used for communication (on a single computer) or sockets (Unix) or something else. The new worker channel can be created, for example when using the Go programming language, which natively supports channels and creates channels using the make( ) primitive, by toWorker:=make(chan Message, size) where Message is the type of messages that are sent over the channel toWorker and size is the channel size. For example, the Go routine for channel creation can be implemented with the following exemplary pseudocode:

```
package main
import “fmt”
func sum(s []int, c chan int) {
  sum := 0
  for _, v := range s {
    sum += v
  }
  c <- sum // send sum to c
}
func main() {
  s := []int{7, 2, 8, −9, 4, 0}
  c := make(chan int)
  go sum(s[:len(s)/2], c)
  go sum(s[len(s)/2:], c)
  x, y := <-c, <-c // receive from c
  fmt.Println(x, y, x+y)
}
```

The parent workers 42, 44 are determined using the key-value store of the dispatcher 22. An event determines keys. These keys usually depend on the event's data values. For each such key, the dispatcher 22 queries its key-value store. If the key is already present, then the corresponding worker already exists. Otherwise, the dispatcher 22 finds all the keys in the key-value store that are direct predecessors. All workers of these keys are the parent workers 42, 44 for the worker for the new key. The primary parent 42 is picked by the dispatcher 22, and any of the determined parent workers can be chosen as the primary parent 42. One heuristic which could be advantageously used for the selection would be to use the parent that has the fewest unprocessed messages in its channel or is using the least resources (memory, CPU usage) at the moment (if such information is available). In step S4.2, the dispatcher 22 sends a creation request message to the primary parent 42 including the worker key for the new worker, an identification of the worker channel and the parent keys. The creation of the keys is application dependent (see the example above). The keys are derived/extracted from an event and usually depend on an event's data values. Each worker 24 corresponds uniquely to a key. Furthermore, each worker 24 has a unique worker channel over which it receives messages. This channel is created by the dispatcher 22. Also, each worker 24 stores the event id of the event it processed last. In a step S4.3 a preworker 45 is started, preferably by the primary parent 42, using the worker key and worker channel from the creation request message from the dispatcher 22. The preworker 45 is initialized with the same state as the primary parent 42. In step S4.4, which can also be performed earlier or later, the dispatcher updates its key-value store to include the new worker, new worker channel and event id of the event for the new worker. In step S4.5, which likewise can be performed earlier (even before starting the preworker 45) or later, the dispatcher 22 requests state information from the secondary parents 44, which reply, preferably to the preworker 45, with state information and worker key in step S4.6. In step S4.7, the state information from the secondary parents 44 is used to construct the state until the state is complete and the new worker is started. It is not necessary in all embodiments to have secondary parents 44 and the state information from the primary parent 42 only can be used. The dispatcher 22 sends the parent keys to the primary parent 42. This way, the preworker knows the number of parents from which it should receive state information by knowing the number of parent keys.

In order to communicate with each other, the preworker/workers/parents use the channels that are created by the dispatcher 22 as discussed above. The dispatcher 22 creates a new channel for each preworker/new worker. The information about this new channel is included in the message to the parents, in particular, the secondary channels. For example, the Go programming language natively supports channel communication. In Go, channels are values and can, e.g., be passed as any other value to functions. Other programming languages have libraries for supporting channel communication. Channels are not limited to process communication on a single computer. Channels can also be used for the communication between processes on different computers.

FIG. 5 illustrates a protocol 50 for terminating a worker 24 according to an embodiment of the present invention. In step S5.1, which can be performed continuously, periodically, after a certain amount of (idle) time or after processing an event, the worker 24 determines whether it is in a terminable state, or in other words, that its state matches a termination condition. If so, the worker 24 sends a termination request over the feedback channel to the dispatcher 22 including its key and the last event id processed by the worker in step S5.2. In step S5.3, the dispatcher 22 compares the event id in the termination request with the event id in the key-value store of the dispatcher for the respective worker 24 requesting termination. If there is no match, the termination request is ignored. If there is a match, the dispatcher updates its key-value store by removing the key for the respective worker 24 and, in step S5.4, the dispatcher 22 sends a termination acknowledgement message to the respective worker 24 over the respective worker channel. Upon receiving the termination acknowledgement, the respective worker 24 can then safely terminate in step S5.5. In this case, the respective worker 24 can terminate the execution of its running program and release all of its resources, such as allocated memory.

It is also possible according to an embodiment of the present invention for the dispatcher 22 or another component to perform the termination checks. For example, the dispatcher 22 or the other component could receive the state information from worker 24 for the termination checks.

It is further a possibility for the dispatcher 22 to delete a worker's key from its key-value store. If the dispatcher 22 does this, the worker 24 does not exist anymore for the dispatcher 22, but would still consume memory (although it would not receive any new events and would be idle all the time). Where communication is restricted to the given channels, the dispatcher 22 terminates a worker 24 by sending a termination acknowledgment message. In an embodiment of the present invention using the programming language Go, the dispatcher 22 and the workers 24 run in separate Go routines and communicate over channels, and thereby the dispatcher 22 terminates a worker 24 by sending a termination acknowledgment message over the respective channel, preferably after receiving the termination request indicating the worker 24 is in a terminable state. If, however, for example, the dispatcher 22 and workers 24 are different Unix programs, the dispatcher 22 could send a “kill” signal which would cause the operating system to then essentially terminate the worker program.

It is further possible that the dispatcher 22 could send a termination acknowledgement to a worker 24, without receiving a termination request previously from the respective worker 24. The worker 24 would then terminate when processing the termination acknowledgment (provided the event ids match), However, this would preferably only be used where the dispatcher 22 knows or would check first whether the respective worker 24 is in a safe state to terminate. This is not preferred, however, because such a check would put an additional workload on the dispatcher 22 and might delay the dispatcher 22 to send events quickly to the workers 24.

Embodiments of the present invention provide for the following improvements:
1. Slicing event streams increases scalability and provides for parallelization real-time analyses on the event streams. Embodiments of the present invention also provide for the ability to terminate irrelevant workers and release their allocated resources, thereby freeing up and saving computational resources and associated computational costs. This is significant since even an idle worker that does not receive any messages for updating its state still consumes memory. Since data streams are infinite, these “zombie” workers can cause the system to swap memory or exhaust memory.
2. Terminating inactive workers early also in many cases increases computational performance because the dispatcher must send events to fewer workers and thus fewer state updates take place. Benchmarks have shown that it is significantly more computational-cost efficient to terminate workers and to recreate them later when needed instead of having them “alive” all the time.
3. Utilizing the protocol to safely terminate workers including checking on the worker's maintained state. This check is performed by the worker itself. Advantageously, it suffices according to an embodiment of the present invention to check whether certain state variables are currently set to initial values. The overhead for the dispatcher is very small and the protocol does not globally lock the system (e.g., pausing other workers).
4. Utilizing the protocol to create new workers, in particular, including the initialization of a worker's state by receiving the values from multiple parent workers. Again, the overhead for the dispatcher is very small and the protocol does not block or pause workers that are irrelevant for the worker's creation.
5. Providing and utilizing a grouping of a worker's state into state variables. At the core of this grouping is the key hierarchy provided by the partial order of the keys. Intuitively speaking, the state variables of workers with larger keys subsume the state variables of workers with smaller keys.

According to embodiments of the present invention, an appropriate key set is chosen for the analysis at hand, preferably by selecting a key set which achieves good parallelization. The key set is used for slicing the data stream into substreams, which are then processed in parallel.

Embodiments of the present invention can be implemented in IoT platforms and/or cloud services (FIWARE) to improve the processing of data streams therein. Embodiments of the present invention can also be applied for enhancing security operations centers (SOCs), which also analyze data streams, by being implemented in the SOCs.

Embodiments of the present invention can be implemented using multiple computers or CPUs which communicate with each other for analyzing event streams. Their communications is observable. Such a distributed system can check the data streams for events that trigger a certain action such as the termination of a worker.

Many frameworks for processing data streams provide an application programming interface (API) which can be used to program how data stream elements are processed and what analysis is to be carried out (e.g., the state of a worker, how the states are updated, possibility of terminating workers and conditions for their termination).

Different approaches for slicing and processing data streams in parallel are described in U.S. Pat. Nos. 9,244,978 B2; 9,805,101 B2; and 10,757,140 B2, each of which are hereby incorporated by reference herein. Rosu and Feng, “Semantics and Algorithms for Parametric Monitoring,” Logical Methods in Computer Science, Vol. 8 (2020) and Basin, Caronni, Ereth, Harvan, Klaedtke, and Mantel, “Scalable offline monitoring of temporal specifications,” Formal Methods in System Design, Vol. 49 (2016), each of which are hereby incorporated by reference herein, discuss slicing event streams in different settings. Rosu and Feng, “Semantics and Algorithms for Parametric Monitoring,” Logical Methods in Computer Science, Vol. 8 (2020) also discuss the creation of workers in a different setting with a different technique (see also Havelund, Reger, Thoma, and Zalinescu, “Monitoring Events that Carry Data,” Lecture Notes in Computer Science, Vol. 10457 (2018), which is hereby incorporated by reference herein). Groene and Tabeling, “A System of Patterns for Concurrent Request Processing Servers,” 2nd Nordic Conference on Pattern Languages of Programs (2003), which is hereby incorporated by reference herein, discuss a different application area and different requirements for workers. In contrast to current approaches, embodiments of the present invention provide enhanced security by providing a safety check utilizing a condition for checking whether it is safe for a worker/monitor to terminate. Further, in contrast to current approaches, embodiments of the present invention provide for a dedicated protocol for creating and initializing workers/monitors in a concurrent setting.

Without the termination of workers, alternative approaches to process data streams would require allocating more computational resources (e.g., more CPU cores in a data center) resulting in computational costs (e.g., processing power and energy). Further, in such alternative approaches the dispatcher may become a bottleneck as it has to manage too many workers.

Embodiments of the present invention have been demonstrated in experiments to provide a significant saving in memory usage and faster running times relative to current approaches.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for processing slices of a data stream in parallel by different workers, the method comprising:
receiving events of the data stream and forwarding the events to respective ones of the workers for updating respective states of the respective workers and for outputting results of data processing of the events, wherein the states comprise hierarchically grouped state variables,
wherein at least one of the workers checks whether it is in a terminable state by checking that state variables that are owned by the worker in a current state of the worker have initial values.

2. The method according to claim 1, further comprising receiving a termination request from at least one of the workers that determines it is in the terminable state, and sending a termination acknowledgement for terminating the at least one worker that sent the termination request.

3. The method according to claim 2, wherein the termination request includes an event id, the method further comprising, prior to terminating the at least one worker, checking that the event id in the termination request matches an event id in a key-value store for a key corresponding to the at least one worker that sent the termination request, wherein the at least one worker terminates itself based on receiving the termination acknowledgement.

4. The method according to claim 1, further comprising, for each of the received events, extracting data values and determining a key for the respective event based on the extracted data values using a key-value store having keys for each of the workers, wherein the events are forwarded to the respective workers based on the determined keys.

5. The method according to claim 4, further comprising updating the key-value store for each of the received events, each of the keys in the key-value store including an identification of at least one of the workers and/or a worker channel, and an event id of a most recent event sent to the respective worker.

6. The method according to claim 4, further comprising determining that, for one of the received events, the key does not have a corresponding worker, and generating a new worker.

7. The method according to claim 6, wherein the new worker is generated by:
creating a new worker channel;
determining at least one parent worker using the key-value store; and
initializing the new worker using the state of the at least one parent worker and the new worker channel.

8. The method according to claim 7, wherein the at least one parent worker includes a primary parent and secondary parents, wherein the new worker is initialized with the state of the primary parent, and wherein at least some of the state variables from the secondary parents are used to update the state of the new worker.

9. The method according to claim 7, further comprising updating the key-value store to include the new worker and the new worker channel for the respective received event, and to remove the worker to be terminated and a corresponding worker channel.

10. The method according to claim 1, further comprising:
receiving a termination request from at least one of the workers that determines it is in the terminable state;
checking whether the at least one worker has any upcoming events for processing and sending a termination acknowledgement to the at least one worker only in a case that it is determined that the worker does not have any upcoming events for processing; and
the at least one worker terminating itself upon receiving the termination acknowledgement.

11. The method according to claim 1, further comprising receiving a termination request from at least one of the workers that determines it is in the terminable state, wherein the termination request includes the state variables that are initial and not owned by the at least one worker, the method further comprising sending a termination acknowledgment to the at least one worker and additional ones of the workers having smaller keys than the at least one worker and owning a subset of the state variables in the termination request.

12. A data stream processor for processing slices of a data stream in parallel by different workers, the data stream processor comprising one or more processors and physical memory implementing a dispatcher and the different workers, the one or more processors being configured by instructions in the memory to facilitate the following steps:
receiving events of the data stream and forwarding the events to respective ones of the workers for updating respective states of the respective workers and for outputting results of data processing of the events, wherein the states comprise hierarchically grouped state variables,
wherein at least one of the workers checks whether it is in a terminable state by checking that state variables that are owned by the worker in a current state of the worker have initial values.

13. The data stream processor according to claim 12, wherein the at least one worker is configured to send a termination request to the dispatcher upon determining that it is in the terminable state, wherein the dispatcher is configured to check whether the at least one worker has any upcoming events for processing upon receiving the termination request and to send a termination acknowledgement to the at least on worker in a case it is determined the at least one worker does not have upcoming events for processing, and wherein the at least one worker is configured to terminate itself upon receiving the termination acknowledgment.

14. The data stream processor according to claim 13, wherein the at least one worker is configured to send a termination request to the dispatcher upon determining that it is in the terminable state, wherein the termination request includes the state variables that are initial and not owned by the at least one worker, and wherein the dispatcher is configured to send a termination acknowledgment to the at least one worker and additional ones of the workers having smaller keys than the at least one worker and owning a subset of the state variables in the termination request such that the at least one worker and the additional ones of the workers terminate.

15. A tangible, non-transitory computer-readable medium having instructions thereon which, upon being executed by one or more processors, facilitate execution of the following steps:
receiving events of the data stream and forwarding the events to respective ones of the workers for updating respective states of the respective workers and for outputting results of data processing of the events, wherein the states comprise hierarchically grouped state variables,
wherein at least one of the workers checks whether it is in a terminable state by checking that state variables that are owned by the worker in a current state of the worker have initial values.
